(19) United States
(12) Patent Application Publication
(10) Pub. No.: US 2009/0008269 A1
(43) Pub. Date: Jan. 8, 2009

(54) ELECTROCOAGULATION REACTOR AND WATER TREATMENT SYSTEM AND METHOD

(76) Inventor: Christopher William Heiss, Colorado Springs, CO (US)

Correspondence Address: MARSH, FISCHMANN & BREYFOGLE LLP, 8055 East Tufts Avenue, Suite 450, Denver, CO, 80237, US

(21) Appl. No.: 12/168,753

(22) Filed: Jul. 7, 2008

Related U.S. Application Data
(63) Continuation of application No. PCT/US2008/069285, filed on Jul. 6, 2008.
(60) Provisional application No. 60/948,293, filed on Jul. 6, 2007.

(51) Int. Cl. C02F 1/463

(52) U.S. Cl. 205/751; 204/275.1

(57) ABSTRACT

An electrocoagulation reactor, and water purification systems and methods using the reactor, are provided. The electrocoagulation reactor has a spirally wound assembly in which electrocoagulation treatment takes place. The spirally wound assembly includes electrode sheets spirally wound in spaced relation with an area for fluid flow in the space between the electrode sheets.

### CROSS-REFERENCE TO RELATED APPLICATIONS

This application claims priority to U.S. Provisional Patent Application 60/948293 filed Jul. 6, 2007, the entire contents of each and every portion of which is incorporated herein by reference as if set forth herein in full. This application is a continuation of prior international patent application PCT/US08/69285, which designated the United States, filed Jul. 6, 2008, the entire contents of each and every portion of which is incorporated herein by reference as is set forth herein in full.

### FIELD OF THE INVENTION

The present invention relates to electrocoagulation treatment of aqueous liquids.

### BACKGROUND OF THE INVENTION

Electrocoagulation is a water treatment technique in which an aqueous liquid to be treated is passed between two electrically powered electrodes, an anode and a cathode, connected to an electrical power source that causes an electrical potential to be applied between the electrodes and electrical current to flow between the electrodes and through the liquid. Contaminants to be removed from the liquid form insoluble solids in a flocculated or coagulated form that tend to be relatively easy to separate from the liquid, such as by filtration or sedimentation. During the process, ions of anode material are released from the anode and reactions at the cathode tend to passivate the cathode and reduce its activity over time. Typically, polarity is periodically reversed so that electrodes spend equal time as anode and cathode to provide even wear on electrodes. Due to the loss of material at the anode and the loss of electrode activity at the cathode, the electrodes must occasionally be replaced, and are therefore sometimes referred to as “sacrificial” electrodes. Although electrocoagulation can be conducted using AC (alternating current) electrical power, more commonly it is conducted using DC (direct current) electrical power.

Although a simple configuration for an electrocoagulation reactor includes just two electrodes with a space between the electrodes for flow of the liquid to be treated, the need to treat larger volumes of water and practical design considerations has led to common reactor designs that include banks of large numbers of closely-spaced electrode plates. Such reactors may contain hundreds of electrode plates. The inclusion of a large number of electrode plates, however, introduces significant complexities. For example, reactors that have such a large number of plates also have significant mechanical systems for retaining the large number of plates, and must have a design that accommodates removal and replacement of a large number of plates, as plates are depleted and need to be replaced.

Additional complexities may also be introduced due to the large number of electrical connections that may be required by the use of a large number of electrode plates. For example, one type of reactor design includes large numbers of electrode pairs electrically connected in parallel. The complexity involved with providing electrical power connections to each of the many electrode plates is significant. One design that at least partially addresses this problem reduces the number of powered electrodes (i.e., those with an electrical connection to the electrical power source) by inserting a number of intermediate plates, which do not have such electrical connections, between a pair of powered electrode plates that do have electrical connections. These intermediate plates are in the electrical circuit completed by the aqueous liquid that is being treated in the reactor, and provide a source of metal ions for participation in electrocoagulation reactions. Reactors of this design reduce the number of electrical connections that need to be made, but may have an additional problem relating to the larger separation distance between powered electrode plates that results from inserting the intermediate plates. These reactors have higher resistance and tend to operate at significantly higher voltages at least in some situations than reactor designs in which all plates are powered through electrical connections to the electrical power source. Commercially available input electrical power is often delivered as AC power. For an electrocoagulation reactor requiring DC power, it is necessary to convert the AC power to DC power in a rectifier to provide a DC power source for operation of the electrocoagulation reactor. However, providing the higher DC voltages that may be used in these reactor designs results in more watts of AC power usage.

It would be desirable to have an electrocoagulation reactor with a less complex design and/or that permits efficient use of available AC electrical power.

### SUMMARY OF THE INVENTION

In one aspect the present invention provides electrocoagulation reactors in which the electrocoagulation occurs within a spirally wound assembly of spaced electrode sheets. In another aspect, the invention provides systems for water purification that include one or more of the electrocoagulation reactors. In one variation, a water purification system includes, downstream of an electrocoagulation reactor, a solids separator for separating solids from the liquid treated in the reactor by electrocoagulation. In yet another aspect, the invention provides methods for treating aqueous liquids, including electrocoagulation treatment in one or more of the electrocoagulation reactors

The spirally wound assembly used in the electrocoagulation reactors of the invention can advantageously be configured generally in a cylindrical shape that can easily be inserted into and retained within a tubular section of a reactor housing. Because of the spirally wound packing of the electrode sheets, a large electrode surface area is obtainable using only two powered electrodes, although use of a greater number of powered electrodes is possible if desired for a particular application. Also, because the separation distance between the powered electrode sheets can be kept small without the need to make a lot of electrical connections, the reactor can be readily designed for operation at lower voltages for many applications. The electrocoagulation reactor, and the spirally wound assembly, may be operated using AC or DC electrical power, but more often is operated using DC electrical power, and often in a range of 1.5 DC volts to 48 volts DC.

Advantageously, in a preferred design the spirally wound assembly can be configured to fit into and efficiently use the space available in a tubular section of a reactor housing. This is possible because spiral winding is well adapted to making a spirally wound assembly that is generally of cylindrical shape, which can be closely fitted into a tubular housing section to efficiently use available internal reactor volume. Also, because all of the electrode surface area needed for the electrocoagulation reaction is contained within the spirally wound structure, the manufacture and maintenance of the electrocoagulation reactor is not particularly complex. Also, changing electrodes as they are depleted can be accomplished relatively easily by opening the reactor housing, removing the old spirally wound assembly, inserting the new spirally wound assembly, replacing any retaining or sealing pieces as needed, and closing the reactor housing. Also, with a tubular design, the electrocoagulation reactor can often be constructed of generally available components, and without significant mechanical complexity. Additionally, such tubular-based reactors are easily manifolded into a bank of multiple reactors for parallel or series processing through the multiple reactors. For example, additional reactors can easily be added in parallel to increase throughput capacity, or additional reactors can easily be added in series to provide for added reactor length, such as for longer reaction times. Because of the modular design, systems can be accurately scaled up from bench scale to application scale. Usually electrocoagulation systems are piloted on a specific water to determine the efficacy of the process and predict the cost. Multiple modules perform the same as opposed to single reactors with different size and numbers of plates than pilot. Also use of a single set of electrodes aids in accurate scaling. Amps per unit area of electrode surface remains consistent on a given water supply.

### BRIEF DESCRIPTION OF THE DRAWINGS

FIG. 1 is a perspective view of one embodiment of an electrocoagulation reactor.

FIG. 2 is a sectional view of the embodiment of FIG. 1 showing an embodiment of the spirally wound assembly disposed inside of a tubular reactor housing section.

FIG. 3 is a perspective view of the embodiment of one embodiment of a spirally wound assembly.

FIG. 4 is a partial perspective view of one longitudinal end of one embodiment of a spirally wound assembly.

FIG. 5 is a perspective view of a one embodiment of a spirally wound assembly showing the configuration of sheets in the assembly.

FIG. 6 is a perspective view of one embodiment of an electrocoagulation reactor.

FIG. 7 is a process block diagram for one embodiment of a method for water purification.

FIG. 8 is a schematic of one embodiment of a water purification system.

### DETAILED DESCRIPTION OF THE INVENTION

Reference is now made to the accompanying drawings, to assist in illustrating the various aspects and features of the present invention. In this regard, the following descriptions of particular embodiments for an electrocoagulation reactor, the spirally wound assembly thereof, and systems, methods and uses including an electrocoagulation reactor, are presented herein for purposes of illustration and description. Furthermore, the description is not intended to limit the invention to the particular form or forms disclosed herein. Consequently, variations and modifications commensurate with the teachings presented herein, and the skill and knowledge of the relevant art, are within the scope of the present invention. The embodiments described herein are further intended to explain the best modes known of practicing the invention and to enable others skilled in the art to utilize the invention in such, or other embodiments and with various modifications required by the particular application(s) or use(s) of the present invention.

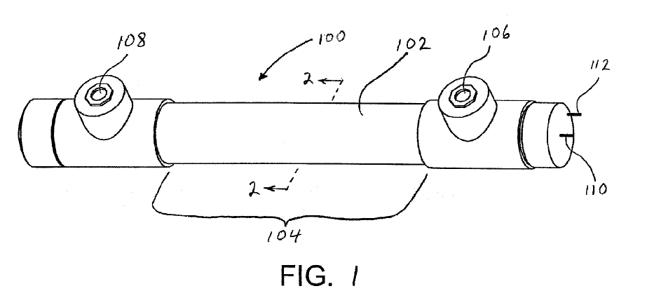

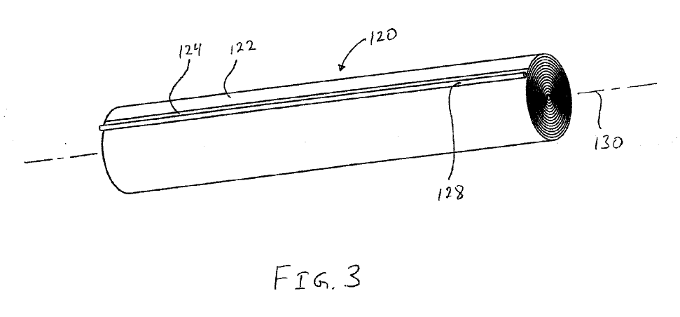

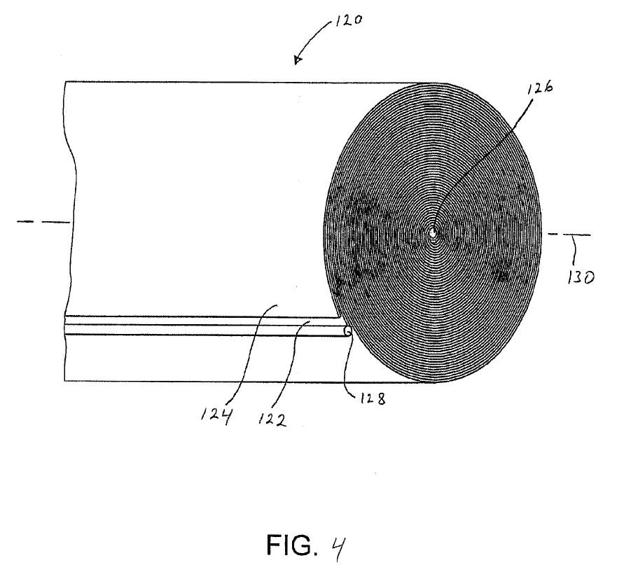

FIGS. 1-4 illustrate an electrocoagulation reactor 100, including a spirally wound assembly 120. The reactor 100 has a housing 102, inside of which is an internal reactor volume through which the flow of an aqueous liquid would be directed for electrocoagulation treatment. The internal reactor volume is disposed in a tubular section 104 of the housing 102 that is located between a fluid inlet 106 and a fluid outlet 108. During operation of the reactor 100, an inlet flow of liquid to be treated is directed into the internal reactor volume through the fluid inlet 106 and treated liquid is directed out of the reactor through the fluid outlet 108 after being treated by electrocoagulation in the internal reactor volume. The housing 102 may be constructed of any material or materials suitable for containing the liquids to be processed at pressures to be encountered during processing. For many applications, PVC (polyvinylchloride) or other plastic-based materials of construction are suitable. Two electrical contacts 110 and 112, made of electrically conductive material, are connectable to an external electrical power source for providing electrical power to the reactor for use to drive the electrocoagulation treatment within the reactor 100.

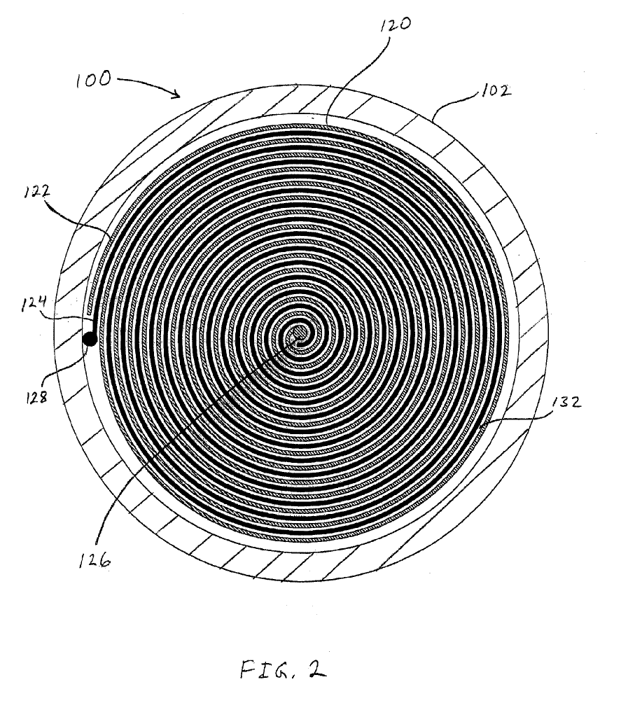

Disposed within the tubular section 104 of the housing 102 is the spirally wound assembly 120, shown in FIGS. 2-4. The spirally wound assembly 120 includes two electrode sheets 122 and 124, which are preferably alternatingly used as an anode and as a cathode when the reactor is operated. Electrically conductive electrode contact members 126 and 128 are attached to the electrode sheets 122 and 124, respectively. The electrode contact members 126 and 128 help to evenly distribute electrical current to the electrode sheets 122 and 124, and may be made, for example, of electrically conductive metal or some other electrically conductive material. The Electrode contact members 126 and 128 are shown in the shape of rods, but could be any other shape suitable for evenly distributing electrical current to the electrode sheets 122 and 124. The Electrode contact members 126 and 128 each form or are part of an electrode contact that is connectable to an external electrical power source to supply electrical power to the electrode sheets 122 and 124. The electrode contact for electrode sheet 122 comprises the electrode contact member 126 and the electrical contact 110, and the electrode contact for electrode sheet 124 comprises the electrode contact member 128 and the electrical contact 112. The electrical contacts 110 and 112 may be terminal ends of the electrode contact rods 126 and 128, respectively, that extend through the end of the housing 102, or one or both of the electrical contacts 110 and 112 may be separate structures from the corresponding electrode contact member 126 or 128, with an electrical interconnection within the housing between the electrode contact member 126 and the electrical contact 110 and/or between the electrode contact member 128 and the electrical contact 112. The attachment of each of the electrode contact rods 126 and 128 to the respective one of the electrode sheets 122 and 124 is by any technique that provides good electrical contact between the electrode contact member and the corresponding electrode sheet, such as a solder or weld connection, clamp, bolt, rivet, press fit, or the use of an electrically conductive adhesive. The electrode sheets 122 and 124 are spirally wound in a spaced relation about an axis 130. The axis 130, which extends in the longitudinal direction of the spirally wound assembly 120 and also in the longitudinal direction of the housing 102, is axially aligned with the first electrode contact member 126 attached to the first electrode sheet 122. As shown best in FIG. 2, there is a space 132 that separates the electrode sheets 122 and 124, and which space 132 provides for separation of the electrode sheets 122 and 124 through the entire spiral winding of the spirally wound structure.

The electrode sheets 122 and 124 may be sufficiently rigid that there is no need to place a spacer in the space 132 to maintain the separation between the electrode sheets. This may be the case, for example, when the electrode sheets are sheets made of a sheet metal, such as sheet metal of steel.

In one variation, a spacer is disposed in the space 132 to assist in maintaining a desired separation between the electrode sheets 122 and 124. This is especially preferred in the case when, due to the particular construction of one of both of the electrode sheets 122 and 124, one or both of the electrode sheets 122 and 124 is sufficiently flexible that it is more susceptible to movement within the spirally wound assembly 120. When used, such a spacer should be made of electrically non-conductive material and should be of a construction that does not prevent a desired level of fluid flow through the space 132 between the electrode sheets 122 and 124 during use of the reactor 120. In one variation, the spacer is a permeably porous sheet of electrically non-conductive material, which is preferably also flexible. Such a sheet may be, for example, made of a plastic material. By permeably porous, it is meant that a sheet has openings extending across the thickness of the sheet through which fluid can flow through the sheet from one side of the sheet to the other side of the sheet.

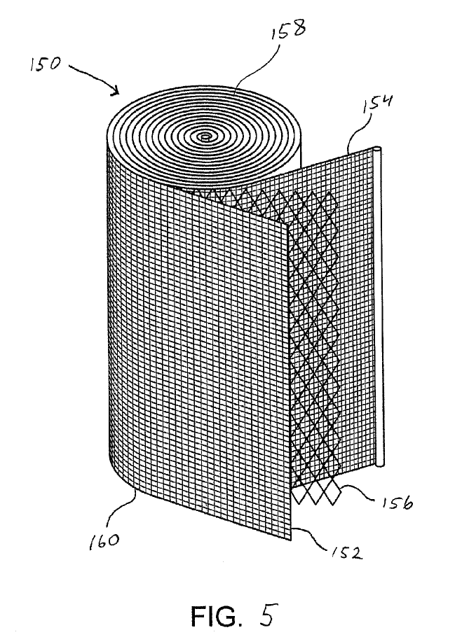

Referring now to FIG. 5, one embodiment of a spirally wound assembly is illustrated that includes a spacer between two electrode sheets. FIG. 5 shows the configuration of three spirally wound sheets in a spirally wound assembly 150. Between two electrode sheets 152 and 154 is disposed a spacer sheet 156. In the configuration shown, both of the electrode sheets 152 and 154 and the spacer sheet 156 are all permeably porous sheets, so that fluids can flow across all of the sheets in the spirally wound assembly 150. The electrode sheets 152 and 154, for example, may each be a mesh sheet of an electrically conductive metal and the spacer sheet 156, for example, may be an open grid of an electrically non-conductive plastic. In the embodiment shown in FIG. 5, fluid flow through the spirally wound assembly 150 would generally be from one end 158, as an inlet end of the spirally wound assembly 150, to the opposite end 160, as a discharge end of the spirally wound assembly 150. But as the fluid moves from the inlet end 158 to the discharge end 160, the fluid can flow in a radial direction back and forth across the different sheets. In the embodiment shown in FIG. 5, the flow path through the spirally wound assembly 150 includes the permeable porosity of the electrode sheets 152 and 154 and the spacer sheet 156. In the embodiment shown in FIG. 5, the pattern of the openings through the spacer sheet 156 (a diamond pattern) is different than the pattern of the openings through each of the electrode sheets 152 and 154 (a square pattern). Using a different pattern for the openings of the spacer sheet 156 tends to reduce the possibility of flow constrictions that might otherwise occur with coincidental alignment of the patterns of adjoining sheets.

The spirally wound assembly used with the electrocoagulation reactor of the present invention, including the embodiments disclosed in FIGS. 1-5, can be made by providing a stack of sheets to be included in the spirally wound structure and then spirally winding that stack of sheets about an axis. The spiral winding can be accomplished for example by winding the stacked layers about a cylindrical mandrel of small diameter that is then removed from the center of the competed spirally wound structure. Alternatively, the spiral winding can be about a rod or other such member or other structure that remains a part of the final spirally wound assembly, such as for example an electrode contact rod as described with reference to FIGS. 1-4. In the situation where the separation space between the electrode sheets is not to be maintained through inclusion of an intermediate spacer in the final spirally wound assembly, then a sacrificial layer can be disposed between the electrode sheets for the purpose of accomplishing the spiral winding, and then removed to make the final structure for the spirally wound assembly. After the spiral winding is complete, the scarification layer is removed by any effective technique suitable for the nature of the sacrificial layer used. For example, the sacrificial layer could be a layer that is susceptible to chemical removal or removal by heat or combustion. For example, a sheet of thick paper or cardboard could initially be interposed in a stack between the electrode sheets and the stack spirally wound. After the spiral winding is complete, then the paper or cardboard could be burned away to leave the desired separation distance between the electrode sheets in the final spirally wound assembly.

The spirally wound assembly is versatile, and can be made in a variety of sizes and configurations and with a variety of materials of construction as desired for a particular application. The spirally wound assembly may include any convenient number of windings. Although there are often at least 3 windings, the number of windings could be 20 or more, 50 or more, or even 100 or more. The separation distance between electrode sheets in the spirally wound assembly may be set at any desired distance, although often the separation distance will be at least 0.5 mm, and even more often will be in a range of from 0.5 mm to 25 mm. The spirally wound assembly can also be made to any convenient dimensions. For many situations the length of the spirally wound assembly (measured end-to-end in the longitudinal direction) will be in a range of from 0.1 m to 3 m in length. The diameter of the spirally wound assembly (determined as the diameter of the smallest circle in which will fit the maximum cross-section taken perpendicular to the longitudinal direction) will often be within a range of from 4 cm to 74 cm. When the spirally wound assembly is disposed in a tubular section of a housing, the inside diameter of the tubular section housing will often be in a range of from 5 cm to 75 cm. The spirally wound assembly will often be generally of cylindrical shape, and so it can advantageously be disposed in a tubular housing section to efficiently use internal reactor volume. When the spirally wound assembly is disposed in a tubular housing section, the spirally wound assembly will often have a diameter that is no more than 10 mm smaller than the inside diameter of the tubular section. Also, the spirally wound assembly will often have a large cross-sectional area for flow of liquid to be treated by electrocoagulation. Often, the area available for flow between the electrode sheets of the spirally wound assembly at any cross-section through the spirally wound electrode assembly taken perpendicular to the longitudinal direction of the assembly will be greater than 25%, and may even be as large as 75% or more, of the total area of the cross-section.

The materials of the electrode sheets of the spirally wound assembly are made of an electrically conductive material or materials suitable for providing ions for electrocoagulation. Some preferred metals that may be used include iron, aluminum and titanium, and in one preferred variation the electrode sheets are metallic and contain as a predominant metal component one of these metals. The electrically conductive sheets can also be made from alloys of these or other suitable metals. Steel and stainless steel compositions are some preferred iron-containing metallic materials for the electrode sheets. The different electrode sheets of a spirally wound assembly do not need to be made of the same material.

The embodiments described with reference to FIGS. 1-5 included only two electrode sheets in the spirally wound structure. Although the use of only two electrode sheets (one anode/cathode pair) is normally preferred due to simplicity of design and construction, more than two electrode sheets (e.g., more than one anode/cathode pair) could be included in the spirally wound assembly. For example, a spirally wound assembly could be made by stacking, in order, a first anode sheet, a first spacer sheet, a first cathode sheet, second spacer sheet, a second anode sheet, a third spacer sheet and a second cathode sheet. This example stack of 7 sheets could then be spirally wound into a spirally wound assembly, and parallel electrical connections could then be made to each of the four electrode sheets that make up the two anode/cathode pairs.

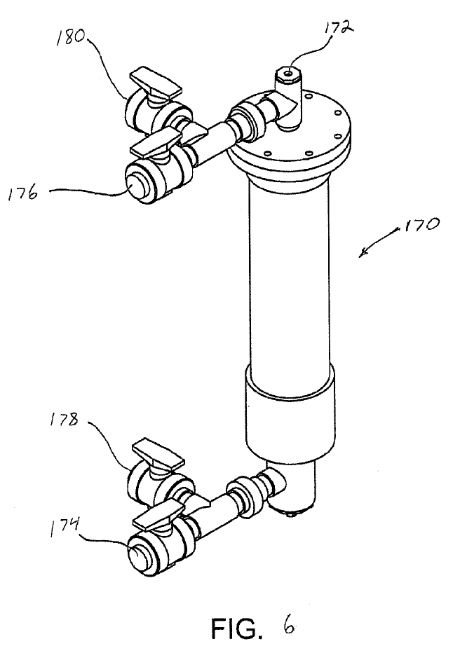

Referring to FIG. 6, another embodiment of an electrocoagulation reactor is illustrated. In FIG. 6, an electrocoagulation reactor 170 has a flanged connection at one end to which is attached a tee with a gas vent port 172, through which gas generated during the electrocoagulation reaction may be vented during operation. For effective gas venting, the reactor should be oriented during operation so that the gas vent port 172 is at a vertically elevated position where gas generated in the reactor will naturally tend to collect. Therefore the reactor 170 should preferably be in a vertical orientation with the gas vent port 172 at the top, or should at least be inclined upward at a sufficient angle, preferably at an angle of 45° or greater. In addition to a fluid inlet 174 and a fluid outlet 176 for directing an inlet flow of liquid into and an outlet flow of liquid out of the internal reactor volume of the reactor 170, the reactor 170 also includes two auxiliary fluid access ports 178 and 180. The auxiliary fluid access ports 178 and 180 can be used, for example, for connecting the reactor 170 to a cleaning circuit for occasionally cleaning out the interior reactor volume, such as by flushing out the internal reactor volume with previously treated water, clean water or a cleaning solutions. For example, flushing may be accomplished using a back flow at a flow rate that is larger than (e.g., two to three times as large as) the normal forward flow rate during normal operation.

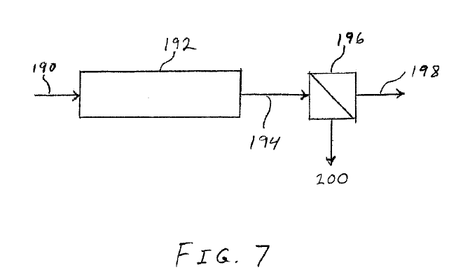

FIG. 7 illustrates one embodiment of a method for treating an aqueous liquid using an electrocoagulation reactor as described herein. As shown in FIG. 7, a feed 190 of an aqueous liquid to be treated is subjected to an electrocoagulation treatment 192. Treated liquid 194 from the electrocoagulation treatment 192 is then subjected to liquid-solid separation to prepare a purified liquid 198 and a solids concentrate 200. In the electrocoagulation treatment 192, the liquid flows through an electrocoagulation reactor, containing a spirally wound assembly, while the reactor is connected to an electrical power source to apply an electrical potential between the electrode sheets in the reactor. As the aqueous liquid passes through the spirally wound assembly within the reactor, it is treated by electrocoagulation. The treated liquid 194 will contain solids as produced or modified during the electrocoagulation treatment 192. The solids may for example, include flocculated or coagulated masses. In the liquid-solid separation 196, at least most of the solids are removed from the treated liquid 194 to produce the purified liquid 198, from which at least most of the solids have been removed, and the solids concentrate 200. The liquid-solid separation 196 may involve one or more liquid-solid separation techniques, including one or more of filtration and gravity settling. For example, the liquid-solid separation may include filtration (e.g., by one or more of media filter, cartridge filter, microfiltration membrane, ultrafiltration membrane, or other filtration technique) or gravity settling, or both.

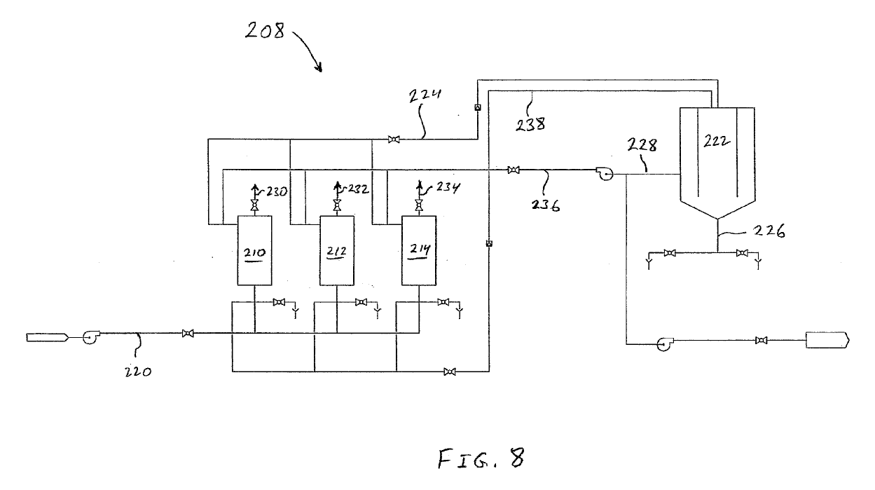

FIG. 8 illustrates one embodiment of a water purification system including an electrocoagulation reactor as described herein. A water purification system 208 includes three electrocoagulation reactors 210, 212 and 214 arranged in parallel and fluidly connected on an upstream end with a feed conduit 220. The reactors 210, 212 and 214 are fluidly connected on a downstream end with a separator vessel 222 through a reactor discharge conduit 224. The separator vessel 222 is fluidly connected to a solids discharge conduit 226 and a purified liquid discharge conduit 228. Gas vents 230, 232 and 234 in fluid communication with the reactors 210, 212 and 214 may be connected to a gas collection system to permit venting of gas generated in the reactors. The system also includes piping to permit backwashing of the reactors using clean water delivered from the separator vessel 222 through conduit 236 and with backwash effluent being returnable to the separator vessel 222 through conduit 238. Advantageously, the water purification system 208 may include appropriate instrumentation and controls, not shown, for monitoring and/or controlling operation of the system. Also, the use of three electrocoagulation reactors is shown for. illustration only, as such a system would include at least one electrocoagulation reactor, but could include multiple electrocoagulation reactors of any number greater than one.

During operation of the system, aqueous liquid feed from the feed conduit 220 is fed to one, two or all three of the reactors 210, 212 and 214 depending upon the volume and quality of the liquid to be treated. The reactors are powered by connection to an electrical power source, more typically a DC electrical power source, and the aqueous liquid is treated by electrocoagulation in the reactors 210, 212 and 214. Discharge of treated liquid exiting the reactors 210, 212 and 214 is transferred to the separation vessel 222 through the reactor discharge conduit 224. In the separation vessel, solids settle due to gravity to the bottom of the settling vessel 222, from which a concentrate, or sludge, containing the solids is removed through solids discharge conduit 226. Purified liquid is removed from the separation vessel 222 through the purified liquid discharge conduit 228.

What is claimed is:

1. An electrocoagulation reactor, comprising:
a reactor housing enclosing an internal reactor volume, the reactor housing comprising:
a fluid inlet for directing an inlet flow of liquid to be treated into the internal reactor volume; and
a fluid outlet for directing an outlet flow of treated liquid out of the reactor volume;
a spirally wound assembly disposed in the internal reactor volume within the housing, the spirally wound assembly comprising:
an electrically conductive first electrode sheet and an electrically conductive second electrode sheet spirally wound in spaced relation about an axis; and
a flow path in fluid communication with the fluid inlet and the fluid outlet and including space between the spirally wound first and second electrode sheets;
wherein, when an electrical potential is applied between the first and second electrode sheets and a flow of aqueous liquid is directed through the internal reactor volume from the fluid inlet to the fluid outlet, at least most of the flow passes through the flow path of the spirally wound assembly and between the spirally wound first and second electrode sheets for electrocoagulation treatment.

2. An electrocoagulation reactor according to claim 1, wherein the first and second electrode sheets in the spirally wound assembly are separated by a separation distance of from 0.5 mm to 25 mm.

3. An electrocoagulation reactor according to claim 2, wherein the spirally wound assembly comprises at least 3 spiral windings of the first and second electrode sheets about the axis.

4. An electrocoagulation reactor according to claim 3, wherein fluid flow through the reactor is in a longitudinal direction in a direction from the fluid inlet toward the fluid outlet;
the axis of the spirally wound assembly extends in the longitudinal direction.

5. An electrocoagulation reactor according to claim 4, wherein the area available for flow between the first and second electrode sheets at any cross-section through the spirally wound electrode assembly perpendicular to the axis is greater than 25% of the area of that cross-section.

6. An electrocoagulation reactor according to claim 5, wherein the housing comprises a tubular section extending in the longitudinal direction, and the spirally wound structure is disposed within the tubular section.

7. An electrocoagulation reactor according to claim 6, wherein the spirally wound assembly is generally of cylindrical shape with a diameter no more than 10 mm smaller than the internal diameter of the tubular section.

8. An electrocoagulation reactor according to claim 6, wherein the spirally wound assembly has a length in the longitudinal direction in a range of from 0.1 m to 3 m.

9. An electrocoagulation reactor according to claim 8, wherein the tubular section has an internal diameter in a range of from 5 cm to 75 cm.

10. An electrocoagulation reactor according to claim 1, wherein the first electrode sheet is a permeably porous sheet of electrically conductive material.

11. An electrocoagulation reactor according to claim 10, wherein the second electrode is permeably porous sheet of electrically conductive material.

12. An electrocoagulation reactor according to claim 11, comprising a spacer disposed between the spirally wound first and second electrode sheets for maintaining a separation distance between the spirally wound first and second electrode sheets.

13. An electrocoagulation reactor according to claim 12, wherein the spacer comprises a flexible, permeably porous sheet of electrically non-conductive material disposed between and spirally wound first and second electrode sheets.

14. An electrocoagulation reactor according to claim 13, wherein the spacer is made of an electrically non-conductive plastic material.

15. An electrocoagulation reactor according to claim 1, wherein the first electrode sheet is a non-permeably porous sheet of electrically conductive material.

16. An electrocoagulation reactor according to claim 15, wherein the second electrode sheet is a non-permeably porous sheet of electrically conductive material.

17. An electrocoagulation reactor according to claim 1, wherein the first and second electrode sheets are each made of metallic material with a predominant metal component selected from the group consisting of iron, aluminum and titanium.

18. An electrocoagulation reactor according to claim 17, wherein the metallic material is selected from the group consisting of an alloy, a steel and a stainless steel.

19. An electrocoagulation reactor according to claim 1, wherein attached to the first sheet electrode is an electrically conductive first electrode contact and attached to the second electrode sheet is an electrically conductive second electrode contact, wherein the first and second electrode contacts extend from inside to outside of the housing and are adapted for connection to an external electrical power source to apply an electrical potential between the first and second electrode sheets.

20. An electrocoagulation reactor according to claim 19, wherein the first electrode contact comprises an electrically conductive rod axially aligned with the axis about which the first and second electrode sheets are spirally wound.

21. A water purification system, comprising multiple ones of an electrocoagulation reactor according to claim 1 fluidly connected in parallel flow.

22. A water purification system comprising:
an electrocoagulation reactor according to claim 1; and
a solids separator in fluid communication with the fluid outlet of the electrocoagulation reactor, for separating solids from liquid exiting the electrocoagulation reactor following electrocoagulation treatment in the electrocoagulation reactor.

23. A water purification system according to claim 22, wherein the solids separator comprises a filter.

24. A water purification system according to claim 23, wherein the solids separator comprises a gravity settling vessel.

25. A method for treating an aqueous liquid, comprising:
flowing aqueous liquid through the electrocoagulation reactor of claim 1 from the fluid inlet through the internal reactor volume and out the fluid outlet while applying an electrical potential between the first and second electrode sheets, thereby treating the water by electrocoagulation in the spirally wound assembly in the internal reactor volume.

26. A method for treating an aqueous liquid according to claim 25, comprising after removing the liquid from the fluid outlet of the electrocoagulation reactor, separating solids from the liquid.

27. A method for treating an aqueous liquid according to claim 25, wherein the electrical potential is from a DC electrical power source.

28. A method for treating an aqueous liquid according to claim 27, wherein the electrical potential is in a range of from 1.5 volts to 48 volts DC.
